(19) United States
(12) Patent Application Publication
(10) Pub. No.: US 2008/0230513 A1
(43) Pub. Date: Sep. 25, 2008

(54) METHOD OF MANUFACTURING INK-JET PRINT HEAD

(75) Inventors: Jin Wook LEE, Seoul (KR); Kyong II Kim, Yongin-si (KR); Sung Joon Park, Suwon-si (KR); JL Woo Kim, Seocho-gu (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/955,428

(22) Filed: Dec. 13, 2007

(30) Foreign Application Priority Data
Mar. 22, 2007 (KR) 2007-28322

(51) Int. Cl. G11B 5/127

(52) U.S. Cl. 216/27

(57) ABSTRACT

A method for manufacturing an ink-jet print head including: preparing a single crystal silicon wafer having a (110) crystal plane orientation, as a substrate; forming a heater to heat an ink, on a front surface of a silicon substrate; forming a trench inward of the heater; forming a flow channel layer defining an ink passage, on the front surface of the substrate; forming a nozzle layer having a nozzle on the flow channel layer; and forming an ink supply channel from a rear surface of the substrate to the trench by anisotropic wet etching.

### CROSS-REFERENCE TO RELATED APPLICATION

This application claims the benefit of Korean Application No. 2007-28322, filed Mar. 22, 2007 in the Korean Intellectual Property Office, the disclosure of which is incorporated herein by reference.

### BACKGROUND OF THE INVENTION

1. Field of the Invention

Aspects of the present invention relate to a method for manufacturing an ink-jet print head, and more particularly, to a method for manufacturing an ink-jet print head having an ink supply channel, by using wet etching.

2. Description of the Related Art

An ink-jet print head is a device that forms an image by ejecting ink droplets onto a desired position on a printing medium. Ink-jet print heads are largely classified as electro-thermal type and piezoelectric type, according to the ink droplet ejection mechanism. The electro-thermal type print head generates bubbles in the ink using a heat source, and ejects the ink droplets by the expansive force of the bubbles.

FIG. 1 is a sectional view illustrating a related art, electro-thermal type, ink-jet print head. As shown in FIG. 1, the electro-thermal type print head generally includes: a silicon wafer substrate 1; an ink supply channel formed on the substrate 1, to supply an ink; a flow channel layer 3 having flow channels 3a and ink chambers 3b, disposed on the substrate 1; and a nozzle layer 4 disposed on the flow channel layer 3, having nozzles 4a corresponding to the ink chambers 3b.

In the ink-jet print head, the ink supply channel 2 is formed by dry etching or wet etching. The dry etching has higher manufacturing costs and manufacturing times, because a batch process cannot generally be performed. The wet etching has an advantage in productivity, because a large number of wafers can be immersed in an etching solution and etched simultaneously.

The wet etching has process control difficulties, in that a desired etching shape cannot be easily achieved. In FIG. 1, the substrate 1 has a (100) crystal lattice orientation (hereinafter, referred to as a “(100) wafer”). The ink supply channel 2 is formed by the wet etching. If the ink supply channel 2 is formed by wet etching on the (100) wafer, inner walls 2a of the ink supply channel 2 are slanted at about 54.7 degrees, due to the crystal structure of the silicon. In such an ink supply channel 2, an opening 2b at the rear surface of the substrate 1 is much larger than an opening 2c at the front surface of the substrate 1. In a print head, this structure is unfavorable for various reasons.

In detail, if the rear opening 2b is large, as shown in FIG. 1, the rear surface has a smaller attachment area, where the ink-jet print head is attached to a cartridge, and thus, the ink may leak. If the size of the substrate 1 is increased, to obtain a sufficient attachment area, the overall size of the print head is also increased. Also, the increased etching of the rear surface of the substrate 1 reduces the structural rigidity of the print head and the print head may be easily deformed or broken by an internal residual stress or an external force.

### SUMMARY OF THE INVENTION

Aspects of the invention provide a method of manufacturing an ink-jet print head that increases productivity, by using wet etching.

Another aspect of the invention provides a method of manufacturing an ink-jet print head having a compact structure and an improved rigidity.

In accordance with aspects of the invention, there is provided a method of manufacturing an ink-jet print head, comprising: forming a trench on a front surface of a silicon wafer substrate having a (110) crystal plane orientation (lattice plane); and forming an ink supply channel from a rear surface of the substrate to the trench, by wet etching.

According to aspects of the present invention, the trench may be formed by dry etching, and may have a rectangular shape, when seen from the front surface of the substrate.

According to aspects of the present invention, the ink supply channel has walls extending perpendicularly with respect to the front and/or rear surfaces of the substrate.

According to aspects of the present invention, the wet etching uses an etching solution including a material selected from the group consisting of KOH, NaOH, TMAH, and a mixture thereof.

In accordance with another aspect of the invention, there is provided a method of manufacturing an ink-jet print head, comprising: forming a heater to heat an ink, on a front surface of a single-crystal silicon substrate having a (110) crystal plane orientation; forming a trench adjacent to the heater; forming a flow channel layer defining an ink passage, on the front surface of the substrate; forming a nozzle layer having a nozzle, on the flow channel layer; and forming an ink supply channel from a rear surface of the substrate to the trench, by anisotropic wet etching.

According to aspects of the present invention, the ink supply channel has walls substantially perpendicular to the rear and/or front surfaces of the substrate.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a sectional view illustrating a related art ink-jet print head;

FIG. 2 is a plan view illustrating an ink-jet print head, manufactured in accordance with aspects of a method of the present invention;

FIG. 3 is a sectional view taken along line I-I in FIG. 2; and

FIGS. 4a-4i are views explaining an exemplary method of manufacturing the ink-jet print head, in accordance with aspects of the present invention.

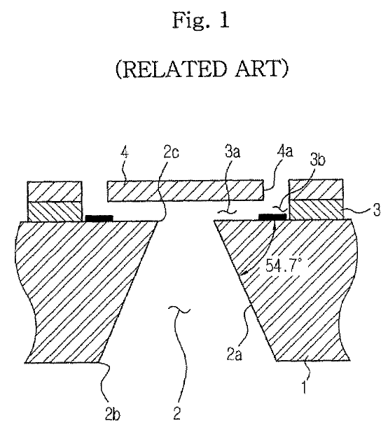

### DETAILED DESCRIPTION OF THE EMBODIMENTS

Reference will now be made in detail to exemplary embodiments of the present invention, examples of which are illustrated in the accompanying drawings, wherein like reference numerals refer to like elements throughout. The embodiments are described below to explain the present invention, by referring to the figures.

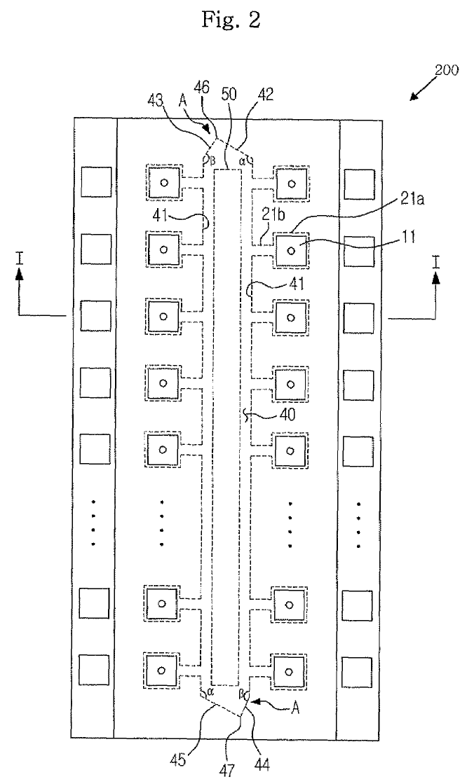

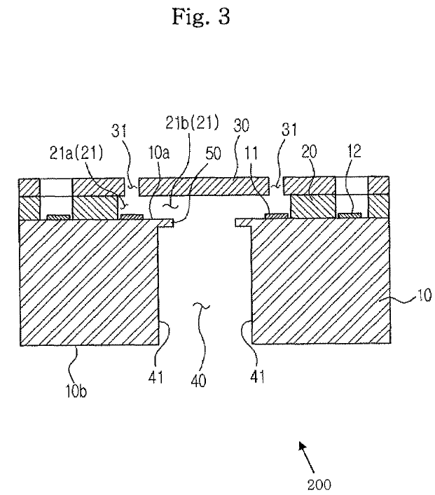

FIG. 2 is a plan view illustrating an ink-jet print head 200, which is manufactured according to aspects of a method of the present invention, and FIG. 3 is a sectional view taken along line I-I in FIG. 2. As shown in FIGS. 2 and 3, the ink-jet print head 200 includes a substrate 10, a flow channel layer 20 disposed on the substrate 10, and a nozzle layer 30 disposed on the flow channel layer 20.

The substrate 10 is formed with an ink supply channel 40 to supply an ink. The ink supply channel 40 is formed by the wet etching, and extends in a longitudinal direction along the ink-jet print head 200. Inner walls 41 of the ink supply channel 40 are formed substantially perpendicular to a rear surface 10b and/or a front surface 10a of the substrate 10. If the ink supply channel 40 is formed substantially perpendicular to the front and/or rear surfaces 10a and 10b, the ink supply channel 40 occupies a minimal amount of the rear surface 10b of the substrate 10.

The flow channel layer 20 defines ink passages 21, which connect the ink supply channel 40 to nozzles 31. Each ink passage 21 has an ink chamber 21a in which an ink is filled, and a restrictor 21b that connects the ink supply channel 40 to the ink chamber 21a. The nozzle layer 30 includes nozzles 31, through which the ink is ejected from the ink chambers 21a.

The front surface 10a of the substrate 10 includes a trench 50 (channel) that extends in the longitudinal direction of the ink-jet print head 200. The trench 50 communicates with the ink supply channel 40, which penetrates the substrate 10. Accordingly, the ink supplied through the ink supply channel 40 flows into the ink passages 21, via the trench 50. Heaters 11 are disposed on both sides of the trench 50, to heat the ink in the ink chambers 21a. Electrodes 12 are disposed adjacent to the heaters 11, to supply electric current to the heaters 11.

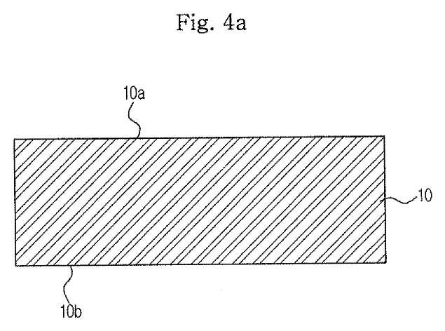

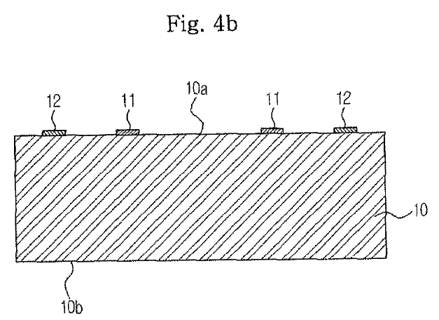

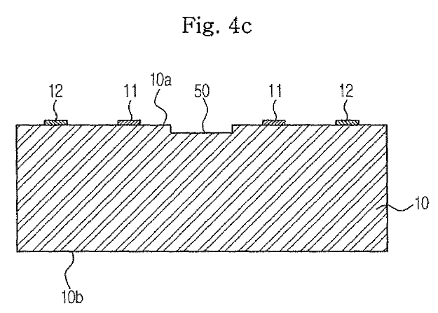

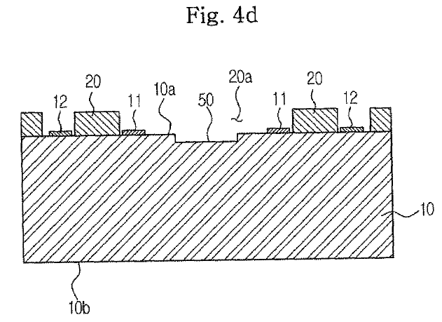

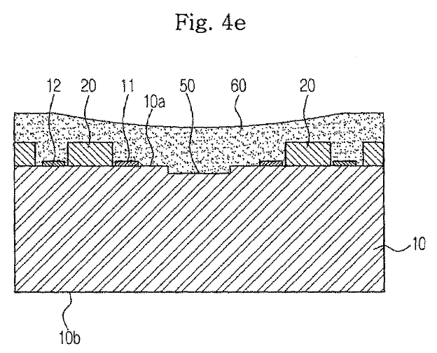

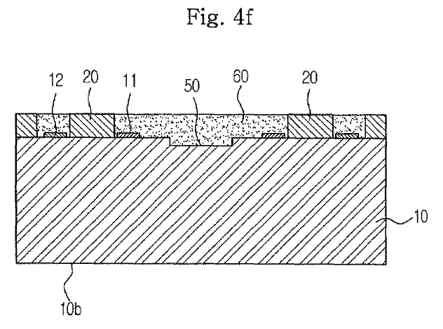

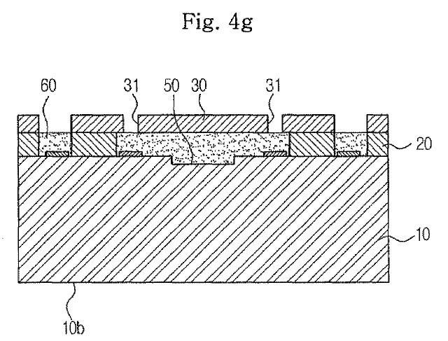

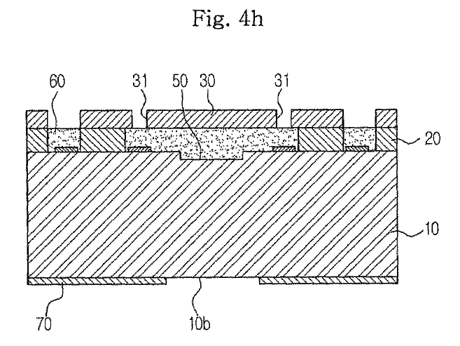

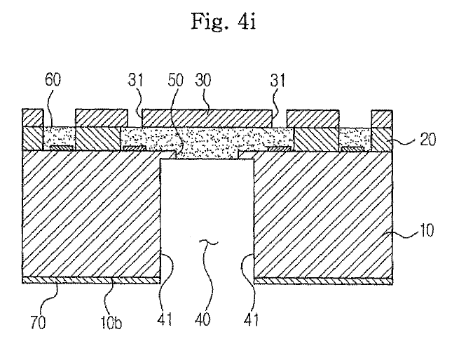

FIGS. 4a-4i are views explaining an exemplary method for manufacturing the ink-jet print head 200, in accordance with aspects of the present invention. As shown in FIG. 4a, the substrate 10 is supplied. The substrate 10 is a single-crystal silicon wafer having a (110) crystal plane orientation (hereinafter, referred to as a “(110) wafer”). The ink supply channel 40 (see FIG. 3) is formed in the substrate 10, such that walls 41 of the channel 40 are substantially perpendicular to the rear surface 10b and/or the front surface 10a of the substrate 10. The ink supply channel 40 can be formed by etching, for example, by anisotropic wet etching. The etching process varies, according to the crystal structure (orientation) of the (110) wafer. The (110) wafer is etched from the rear surface 10b toward the front surface 10a of the substrate 10. The surfaces contacted by the etching solution have different etching velocities, according to crystal plane orientation of the substrate 10.

As shown in FIG. 4b, the heaters 11 and the electrodes 12 are provided on the front surface 10a of the substrate 10. The heaters 11 may be formed by depositing a heat resistant material, such as, tantalum nitride or a tantalum-aluminum alloy, on the substrate 10. The heaters 11 can be deposited by patterned sputtering or chemical vapor deposition. The electrodes 12 may be formed by depositing a metal material having a sufficient conductivity, such as aluminum, by patterned sputtering. A protective layer (not shown), for example, a silicon oxide film or a silicon nitride film, may be provided on the heaters 11 and the electrodes 12.

As shown in FIGS. 2 and 4c, the trench 50 is formed on the front surface 10a of the substrate 10. If the substrate 10 is etched by anisotropic wet etching using a rectangular etching mask, both ends in the longitudinal direction of the ink supply channel 40 are formed like portions “A”, in FIG. 2, due to the etching features of the (110) wafer substrate 10. In detail, a first end in the longitudinal direction of the ink supply channel 40, is formed by etching surfaces 42 and 43, which meet the vertical walls 41 at the angles of α and β, respectively. A second end in the longitudinal direction of the ink supply channel 40 is formed by etching surfaces 44 and 45, which meet the vertical walls 41, at the angles of β and α, respectively.

An edge portion 46 between the etching surface 42 and the etching surface 43, and an edge portion 47 between the etching surface 44 and the etching surface 45, can both be relatively susceptible to residual stress inside the ink-jet print head 200, or to an external force exerted on the ink-jet print head 200. Accordingly, the trench 50 is generally formed in a rectangular shape, so as to mitigate the concentration of loads on the edge portions 46 and 47. The trench 50 can encompass a lip to narrow the ink supply channel 40 (see FIG. 3) at the front surface 10a of the substrate 10. The trench 50 may be formed by the dry etching, e.g., by reactive ion etching (RIE) using plasma, by a cutting tool, or by sand blasting.

As shown in FIG. 4d, the flow channel layer 20 is formed on the substrate 10, on which the heaters 11 and the electrodes 12 have been provided. The flow channel layer 20 can be formed by a photolithography process. Although it is not illustrated in the drawing, the process includes operations of coating a negative photoresist layer on the substrate 10, by a spin coating method, and exposing the photoresist layer to light using a photomask having an ink chamber pattern and a restrictor pattern. The photoresist layer is developed to selectively remove the photoresist that is not exposed to light, to form the flow channel layer 20 defining an ink passage 20a, as shown in FIG. 4d.

As shown in FIG. 4e, a sacrificial layer 60 is formed to cover the front surface 10a of the substrate 10 and the flow channel layer 20. The sacrificial layer 60 may be formed by coating a positive photoresist, for example, by a spin coating method. Because the sacrificial layer 60 is exposed to the etching solution, when etching the substrate to form the ink supply channel 40, the sacrificial layer 60 is generally made of a material highly resistant to the etching solution.

As shown in FIG. 4f, the upper surfaces of the sacrificial layer 60 and the flow channel layer 20 are flattened to the same height. The flattening can be accomplished through a chemical mechanical polish (CMP) process, or the like.

As shown in FIG. 4g, the nozzle layer 30 is formed on the flattened sacrificial layer 60 and flow channel layer 20, The nozzle layer 30 is formed by a photolithography process, similarly to the flow channel layer 20. In other words, after the photoresist is coated on the flow channel layer 20, the photoresist is exposed to light, through a photomask having a nozzle pattern, and is developed to selectively remove a portion thereof that is not exposed to light. The nozzle layer 30 having the nozzles 31 is thereby formed, as shown in FIG. 4g. Since the nozzle layer 30 formed on the flow channel layer 20 can be closely contacted by the flow channel layer 20, the durability of the print head is increased, and the shape and the dimension of the ink passage are controlled accurately, thereby improving the ink ejection performance of the print head.

As shown in FIG. 4h, the etching mask 70 is provided on the rear surface 10b of the substrate 10, to form the ink supply channel 40 (see FIG. 3). The etching mask 70 may be formed by coating a positive or negative photoresist on the rear surface 10b of the substrate 10, and patterning the same.

After forming the etching mask 70, the work piece 210 shown in FIG. 4h is immersed in the etching solution, so that the rear surface 10b of the substrate 10 is etched where exposed by the etching mask 70. The etching is performed until the trench 50 is exposed, to form the ink supply channel 40, as shown in FIG. 4i. Due to the etching features of the (110) wafer substrate 10, the walls 41, in the longitudinal direction of the ink supply channel 40, are formed perpendicularly. As the etching solution, potassium hydroxide (KOH), sodium hydroxide (NaOH), or tetramethyl ammonium hydroxide (TMAH) can be used.

The etching mask 70 and the sacrificial layer 60 as shown in FIG. 4i, are removed to form the ink-jet print head 200, as shown in FIG. 3.

As is apparent from the above description, according to aspects of the manufacturing method of the present invention, since the walls in the longitudinal direction of the ink supply channel can be formed perpendicularly by the wet etching, a compact ink-jet print head, having an improved rigidity, can be manufactured with high productivity.

Although embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of manufacturing an ink-jet print head, comprising:
preparing a silicon wafer having a (110) crystal plane orientation, as a substrate;
forming a trench on a front surface of the substrate; and
wet etching an ink supply channel from a rear surface of the substrate to the trench.

2. The method according to claim 1, wherein the forming of the trench comprises dry etching the front surface of the substrate.

3. The method according to claim 1, wherein the trench has a substantially rectangular cross-section.

4. The method according to claim 1, wherein the ink supply channel has walls extending substantially perpendicular to the front and rear surfaces of the substrate.

5. The method according to claim 1, wherein the wet etching of the ink supply channel comprises using and etching solution comprising a material selected from the group consisting of KOH, NaOH, TMAH, and a mixture thereof.

6. A method of manufacturing an ink-jet print head, comprising:
preparing a silicon wafer having a (110) crystal plane orientation, as a substrate;
forming a heater to heat an ink, on a front surface of the substrate;
forming a trench adjacent to the heater, on the front surface of the substrate;
forming a flow channel layer having an ink passage, on the front surface of the substrate;
forming a nozzle layer having a nozzle, on the flow channel layer; and
anisotropic wet etching an ink supply channel from a rear surface of the substrate to the trench.

7. The method according to claim 6, wherein the ink supply channel has walls extending substantially perpendicular to the front and rear surfaces of the substrate.

8. The method according to claim 6, wherein the trench has a substantially rectangular cross-section.

9. The method according to claim 6, wherein the forming of the trench comprises dry etching the front surface of the substrate.

10. The method according to claim 6, wherein the forming of the trench comprises reactive ion etching, tool cutting, or sand blasting the front surface of the substrate.

11. The method according to claim 1, wherein a width of the trench is less than a corresponding width of the ink supply channel.

12. The method according to claim 1, wherein the wet etching comprises etching the ink supply channel, such that the trench restricts a flow of the ink from the ink supply channel.

13. The method according to claim 1, wherein the substrate is a single-crystal, silicon substrate.
